(19) United States
(12) Patent Application Publication
(10) Pub. No.: US 2013/0055868 A1
(43) Pub. Date: Mar. 7, 2013

(54) Immersible Food Slicer

(71) Applicant: R. Edward Moreth, Ft. Lauderdale, FL (US)

(72) Inventor: R. Edward Moreth, Ft. Lauderdale, FL (US)

(73) Assignee: Remco Technologies, Inc., Ft. Lauderdale, FL (US)

(21) Appl. No.: 13/225,421

(22) Filed: Sep. 3, 2011

(51) Int. Cl. B26D 7/00; B26D 7/26

(52) U.S. Cl. 83/433; 83/435.11

(57) ABSTRACT

A slicer comprising a power base and a removable food support assembly. The food support assembly comprises a support base, a product tray, product tray slides, a bearing assembly, an adjustable plate, a gauge plate adjuster, and a blade. The power base comprises individual supports, a switch unit, a power cable, and a drive motor assembly having a blade drive coupling system. After setting the adjustable plate to the desired thickness using the gauge plate adjuster, the user switches the switch unit to the “on” position to initiate the drive motor assembly, which rotates the blade drive coupling system and, in turn, causes the blade to turn and slice the food product. Once the food product has been sliced, the removable food support assembly is removed from the power base and immersed in water or inserted into a dishwasher for faster, safer, more efficient, and more sanitary cleaning.

### FIELD OF INVENTION

The present invention is directed to a slicer having a power base and a removable food support assembly that can be separated from its power base and immersed in water or inserted into a dishwasher for a faster, more efficient, and more sanitary cleaning.

### BACKGROUND

Commercial food slicers are widely utilized as a rapid and effective means for slicing meats, cheeses, and other types of food. The slicers include a rotatable, disc-like blade and a reciprocating tray that brings the food product into contact with the rotating blade to cut the food product. Most food slicers also include a gauge that adjusts the position of the food in relation to the blade; thereby, allowing the person slicing the food to vary the thickness of the cuts of food. During the slicing process meat, fat, and other debris accumulate in the slicer making unsanitary and an environment prone to the growth of bacteria and the spread of food borne illnesses.

In an effort to clean and sanitize the commercial food slicers after the slicing is complete, the tray, which holds the food product, must be removed from the slicer and hand cleaned. The tray is cleaned by removing it from the slicer, and placing it in a sink for rinsing and cleaning. However, by doing this, much of the food, fat, or other debris remain in the food slicer itself including in the rotatable, disc-like blade. The blade can be cleaned using two different methods. The first way that the blade can be clean is by using a sanitizing solution to hand-wash the blade white it is on the slicer. By cleaning the blade using this method, the user runs the risk of damaging the electrical components by exposing them to water or cleaning solution. The second way the blade can be cleaned is by removing the entire blade from the slicer and hand cleaning it individually so as not to damage the electronic components. Cleaning the various parts of the slicer separately is not only time consuming and inefficient, but it is also very unsanitary. Further, detaching the blade from the slicer for cleaning can also result in unnecessary injury to whomever is doing the cleaning.

Therefore, what is needed is a food grade slicing machine with a removable food support assembly that can be separated from its electric components and placed directly into a dishwasher or submerged into a sanitizing solution for safer, faster, more efficient, and more sanitary cleaning and maintenance.

### BRIEF DESCRIPTION OF THE DRAWINGS

The present invention will be more fully understood and appreciated from the following detailed description taken in conjunction with the drawings.

FIG. 1 is a side view of a slicer incorporating a preferred embodiment of the present invention.

FIG. 2 is a front view of the slicer of FIG. 1.

FIG. 3A is a side view of the removable food support assembly of the slicer of FIG. 1 without the power base.

FIG. 3B is a top view of a power base of the slicer of FIG. 1.

FIG. 4 is a side view of the slicer of FIG, 1 with the removable food support assembly separated from the power base.

FIG. 5 is a front view of the slicer of FIG. 1 with the removable food support assembly separated from the power base.

### DETAILED DESCRIPTION OF A PREFERRED EMBODIMENT

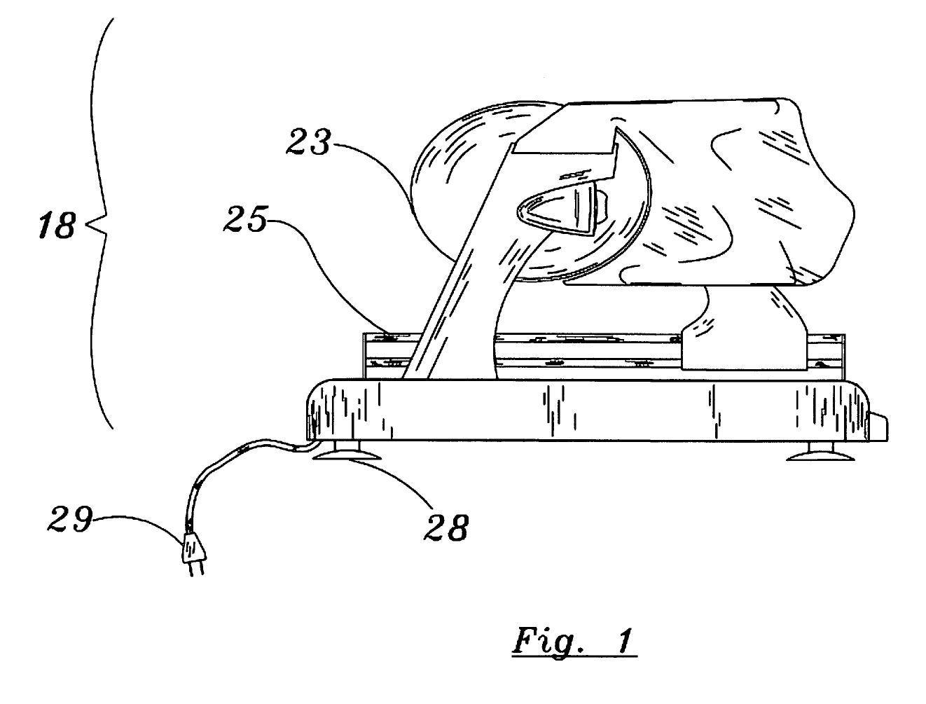

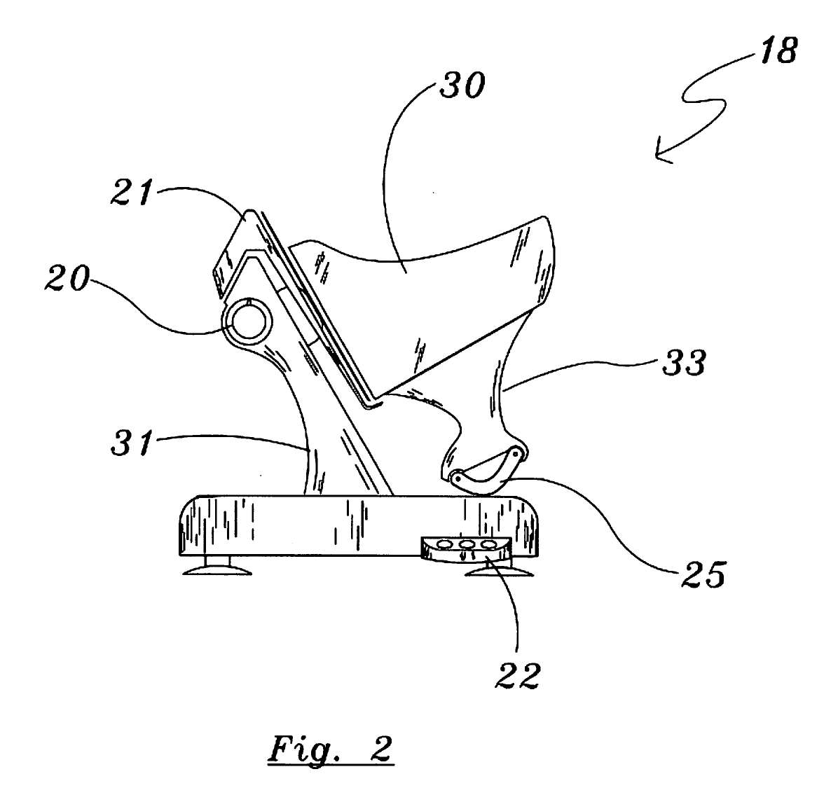

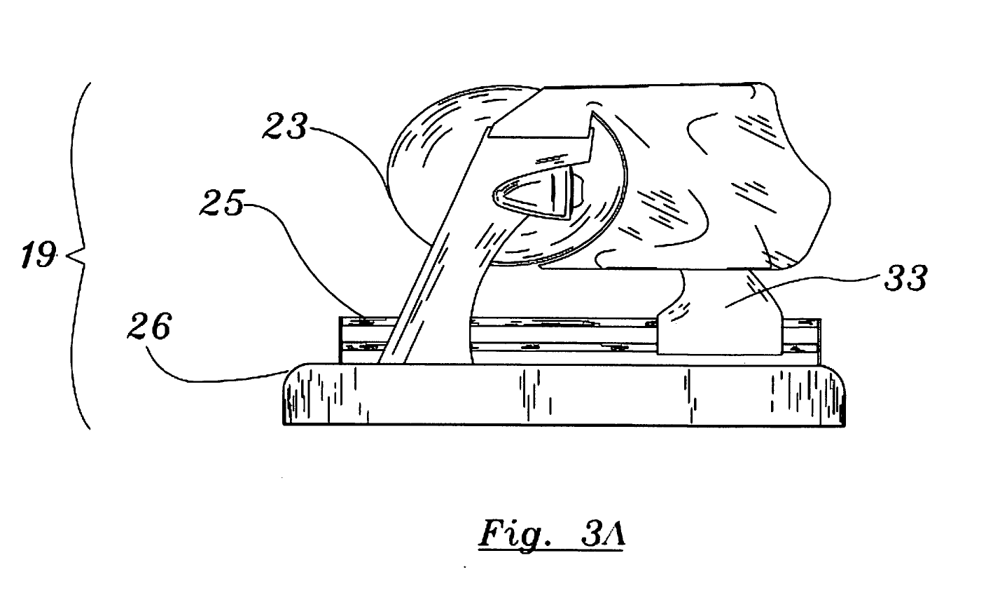

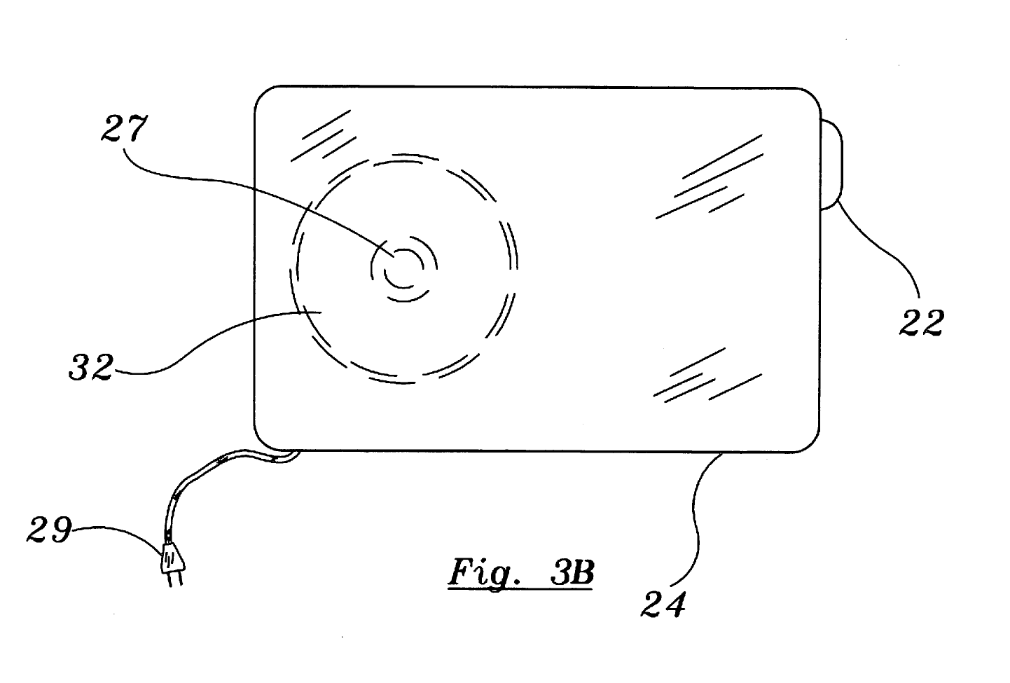

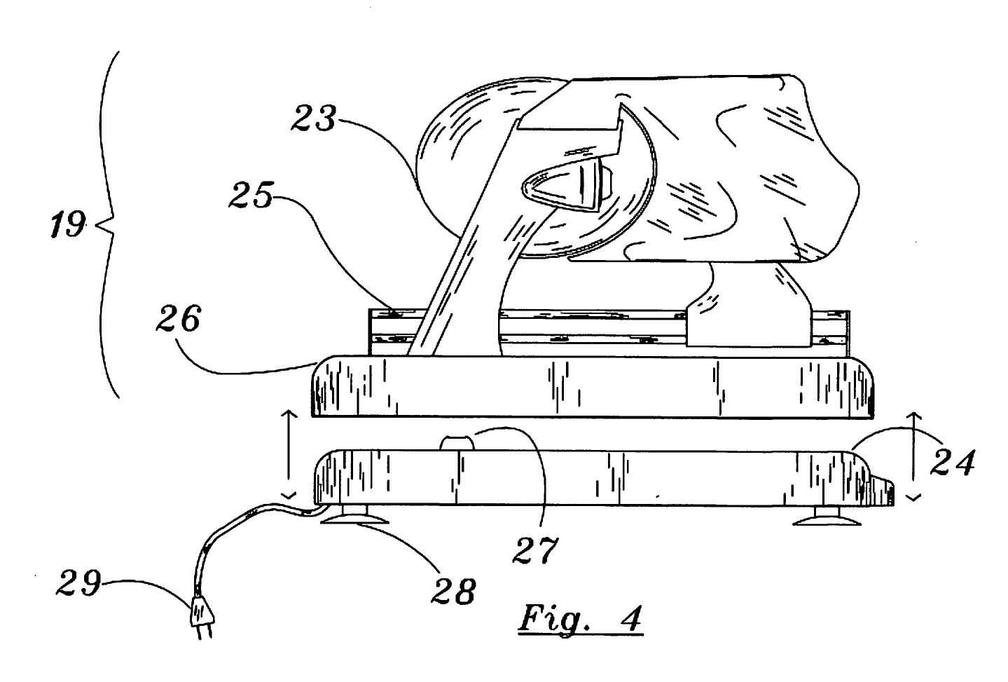

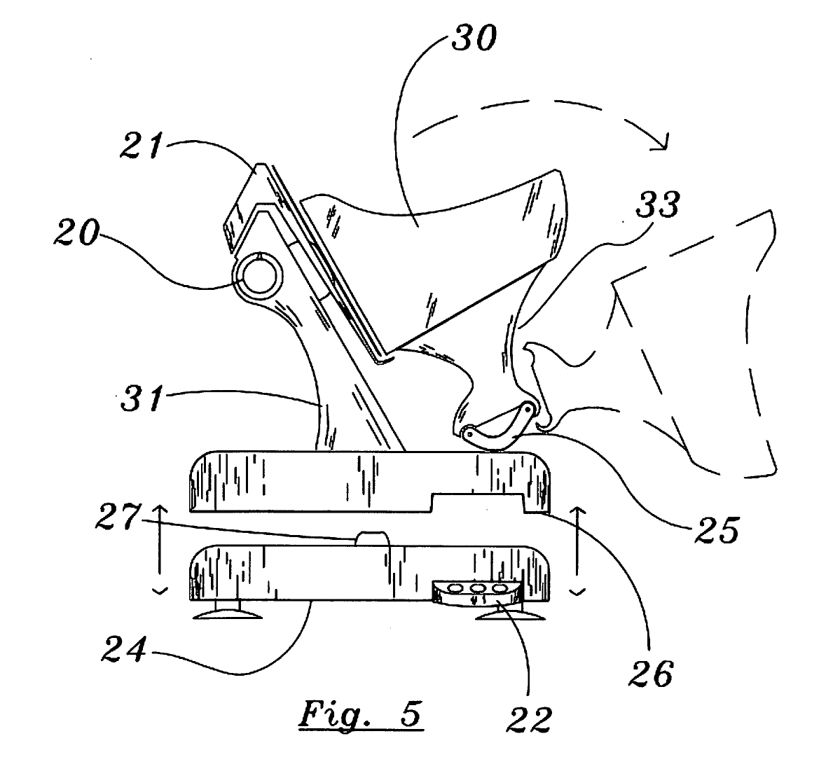

As shown in FIGS. 1 and 2, the present invention is a slicer 18 having a power base 24 (See FIG. 3B) and a removable food support assembly 19 (See FIG. 3A) that can be separated from the power base 24 (as shown in FIGS. 4 and 5). As shown in FIGS. 2 and 4 the removable food support assembly 19 comprises a support base 26, a product tray 30, a tray arm 33, at least one tray slide 25, a drive tree and blade support 31, a bearing assembly (not shown) an adjustable plate 21, a gauge plate adjuster 20, and a blade 23.

As shown in FIGS. 3B and 4, the powerbase 24 comprises individual supports 28, a switch unit 22, a power cable 29, and a drive motor assembly 32 having a blade drive coupling system 27.

Referring to FIG. 2, 3A, and 5, the drive tree and blade support 31 contains an upper portion coupled to the blade 23 and a lower portion coupled to the support base 26. The product tray slides 25 (See FIG. 3A) are coupled to the support base 26 extending from one end of the support base 26 to the other end of the support base 26 (See FIG. 3A). When the slicer 18 is being used, the product tray 30 rests on the adjustable plate 21, which, in turn, is coupled to the drive tree and blade support 31. The selector knob 20, which is coupled to the drive tree and blade support 31, is used to determine the thickness of the food product to be cut.

When in the starting position, the product ray 30 is located furthest from the blade 23 and the gauge plate adjuster 20 must be adjusted so that the adjustable plate 21 will produce a slice of food product of the desired thickness. The product tray 30 is then manually moved along the slicing path created by product tray slides 25 allowing the food product to come into contact with the blade 23 and cut off a slice of food. When the slicer is not in use, the adjustable plate 21, using the gauge plate adjuster 20, can be adjusted so that the plate is flush with the blade 23 so as to protect the blade 23 and unsuspecting users.

Referring to FIGS. 4 and 5, when the support base 26 of the removable food support assembly 19 is coupled to the power base 24, the switch unit 22 (See FIG. 5) is used to turn the slicer 18 on or off. In this embodiment, once the user turns the slicer 18 on using the switch unit 22, the drive motor assembly 32 (See FIG. 3B) rotates and, in turn, drives the blade drive coupling system 27, which causes the blade 23 to rotate and slice the food on the product tray 30.

Having described the invention in detail and by reference to the preferred embodiments, it will be apparent that modifications and variations are possible without departing from the scope of the invention.

What is claimed is:

1. A slicer comprising:
a removable food support assembly; and
a power base.

2. The slicer of claim 1 wherein said removable food support assembly comprises: a tray for receiving a food product, said tray being moveable along a slicing path and having a tray arm;
and a blade for slicing said food product as said tray moves along said slicing path.

3. The slicer of claim 2, wherein said tray and said tray arm are removable from the removable food support assembly.

4. The slicer of claim 2 wherein said removable food support assembly comprises: an adjustable plate for controlling the thickness of the slices of the food product cut by said blade;
and a gauge plate adjuster for controlling the position of said adjustable plate relative to said blade.

5. The slicer of claim 1, wherein said power base comprises a drive motor assembly.

6. The slicer of claim 5, wherein said drive motor assembly comprises a shaft fitted with a blade drive coupling system.

7. A slicer comprising:
a removable food support assembly having a tray for receiving food product to be sliced, said tray having a tray arm being moveable along a slicing path; and a blade for slicing said food product as said tray moves along said slicing path; and
a power base.

8. The slicer of claim 7, wherein said tray and said tray arm are removable from said removable food support assembly.

9. The slicer of claim 7 wherein said removable food support assembly comprises: an adjustable plate for controlling the thickness of the slices of the food product cut by said blade; and a gauge plate adjuster for controlling the position of said adjustable plate relative to said blade.

10. The slicer of claim 7, wherein said power base comprises a drive motor assembly.

11. The slicer of claim 10, wherein said drive motor assembly comprises a blade drive coupling system.

12. A slicer comprising:
a removable food support assembly, wherein said removable food support assembly comprises: a tray for receiving a food product, said tray having a tray arm and being moveable along a slicing path; a blade for slicing said food product as said tray moves along said slicing path;
an adjustable plate for controlling the thickness of the slices of the food product cut by said blade; a gauge plate adjuster for controlling the position of said adjustable plate relative to said blade; and
a power base, wherein said power base comprises a drive motor assembly having blade drive coupling system.
